(19) United States
(12) Patent Application Publication
(10) Pub. No.: US 2020/0003601 A1
(43) Pub. Date: Jan. 2, 2020

(54) FLUID LEVEL SENSOR

(71) Applicant: HEWLETT-PACKARD DEVELOPMENT COMPANY, L.P., Spring, TX (US)

(72) Inventors: Ning GE, Palo Alto, CA (US); Chien-Hua Chen, Corvallis, OR (US); Alexander Govyadinov, Corvallis, OR (US)

(73) Assignee: HEWLETT-PACKARD DEVELOPMENT COMPANY, L.P., Spring, TX (US)

(21) Appl. No.: 16/462,071

(22) PCT Filed: Feb. 23, 2017
(86) PCT No.: PCT/US2017/019104

§ 371 Date: May 17, 2019

(51) Int. Cl. G01F 23/24; G01F 23/00; B41J 2/175; B23K 26/364

(52) U.S. Cl. CPC G01F 23/243; B23K 26/364; B41J 2/17566; G01F 23/0007

(57) ABSTRACT

A fluid reservoir may include a number of metal traces along a wall of the fluid reservoir, and a number of fuse circuits along a length of the metal traces. Each of the fuse circuits may include a fuse along a length of a respective metal trace, and a number of parasitic resistive elements in parallel to the fuse. The parasitic resistive elements reduce current flow through the fuse in the presence of a fluid contained within the fluid reservoir.

### BACKGROUND

Fluid ejection systems and devices may eject fluid. In some examples, such as printing devices, fluid may be ejected onto media in order to form an image or a structure on the media. The fluid may be stored in a reservoir or other volume from which a system or device may draw the fluid. With use, the level or amount of fluid within the reservoir may be depleted.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1A is a cut away view of a fluid reservoir, according to one example of the principles described herein.

FIG. 1B is a cut away view of a fluid reservoir, according to another example of the principles described herein.

FIG. 2 is a diagram of the electrical components of the fluid reservoir, according to one example of the principles described herein

FIG. 3 is a diagram of the fluid reservoir of FIGS. 1A and 18 during a fluid analysis process, according to one example of the principles described herein.

FIG. 4 is a diagram of the fluid reservoir of FIGS. 1A and 1B during a fluid analysis process, according to one example of the principles described herein.

FIG. 5 is a block diagram of a fluid analysis system including the fluid reservoir of FIGS. 1A and 18, according to one example of the principles described herein.

FIG. 6 is a flowchart depicting a method of detecting a level of fluid within a fluid reservoir, according to one example of the principles described herein.

FIG. 7 is a flowchart depicting a method of forming a fluid level sensor, according to one example of the principles described herein.

Throughout the drawings, identical reference numbers designate similar, but not necessarily identical, elements.

### DETAILED DESCRIPTION

As mentioned above, over time, the level or amount of fluid within the reservoir is may be depleted as the system or device ejects the fluid. A number of devices may be used to sense and determine the level or amount of fluid within the reservoir of fluid. In some examples, the devices used to sense and determine the amount of fluid within the reservoir may be complex, and expensive to manufacture.

Examples described herein provide a method of forming a fluid level sensor. The method may include forming a number of metal traces along a wall of a fluid reservoir, and forming a number of fuse circuits along a length of the metal traces. In one example, forming the fuse circuits may include, for each of the fuse circuits, forming a fuse along a length of a respective metal trace, and forming a number of parasitic resistive elements in parallel to the fuse. The parasitic resistive elements reduce current flow through the fuse in the presence of a fluid contained within the fluid reservoir. In one example, the parasitic resistive elements increase the current flow through the fuse when the parasitic resistive elements are not in the presence of the fluid, and the fuse trips in response to the increase in current flow. Forming the number of metal traces along the wall of the fluid reservoir may include forming the number of metal traces using laser direct structuring (LDS). A location of the number of fuse circuits within the fluid reservoir define a corresponding number of levels of fluid within the fluid reservoir. A width within the fuses, a width of the metal traces, a thickness of the metal traces, a design of the parasitic resistive elements within the fuse circuits, or combinations thereof may define a breaking capacity of the fuse circuit.

Examples described herein also provide a fluid reservoir. The fluid reservoir may include a number of metal traces along a wall of the fluid reservoir, and a number of fuse circuits along a length of the metal traces. Each of the fuse circuits may include a fuse along a length of a respective metal trace, and a number of parasitic resistive elements in parallel to the fuse. The parasitic resistive elements may reduce current flow through the fuse in the presence of a fluid contained within the fluid reservoir. The number of metal traces along the wall of the fluid reservoir may be formed using laser direct structuring (LDS). Further, the parasitic resistive elements increase the current flow through the fuse when the parasitic resistive elements are not in the presence of the fluid, and the fuse trips in response to the increase in current flow. The number of fuse circuits within the fluid reservoir define a corresponding number of levels of fluid within the fluid reservoir. Further, a width within the fuses, a width of the metal traces, a thickness of the metal traces, a design of the parasitic resistive elements within the fuse circuits, or combinations thereof define a breaking capacity of the fuse circuit. In response to the fuse tripping in response to the increase in current flow, the fluid reservoir sends a signal to a programmable memory device to permanently change data relating to the fuse.

Examples described herein further provide a fluid cartridge. The fluid cartridge may include a fluid reservoir including walls defining an interior chamber. The fluid reservoir may store fluid in the interior chamber. A number of fuse circuits may be formed along a length of at least one wall of the fluid reservoir such that a respective position of each respective fuse circuit of the number of fuse circuits corresponds to a fluid level of the fluid reservoir. Each respective fuse circuit to change state when the fluid level of the fluid reservoir crosses the respective position of the respective fuse circuit. The fluid cartridge may further include a fluid ejection die fluidly coupled to the fluid reservoir. The fluid ejection die includes nozzles to eject fluid conveyed from the fluid reservoir. The fluid ejection die may further include a programmable memory device electrically coupled to the number of fuse circuits. The programmable memory device may permanently change data stored thereon responsive to a change in state of each respective fuse circuit. Each fuse circuit may include a fuse and a number of parasitic resistive elements in parallel to the fuse. The parasitic resistive elements reduce current flow through the fuse in the presence of a fluid contained within the fluid reservoir. Each respective fuse circuit does not change its state when the fluid level of the fluid reservoir does not cross the respective position of the respective fuse circuit. Further, the number of parasitic resistive elements in parallel to the fuse increase current flow through the fuse to a point of tripping when at least one parasitic element is not in the presence of a fluid contained within the fluid reservoir. Each respective fuse circuit changes its state when the fluid level of the fluid reservoir crosses the respective position of the respective fuse circuit. In response to the fuse tripping in response to the increase in current flow, a signal is sent to a programmable memory device to the programmable memory device to permanently change data relating to the respective fuse circuit.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

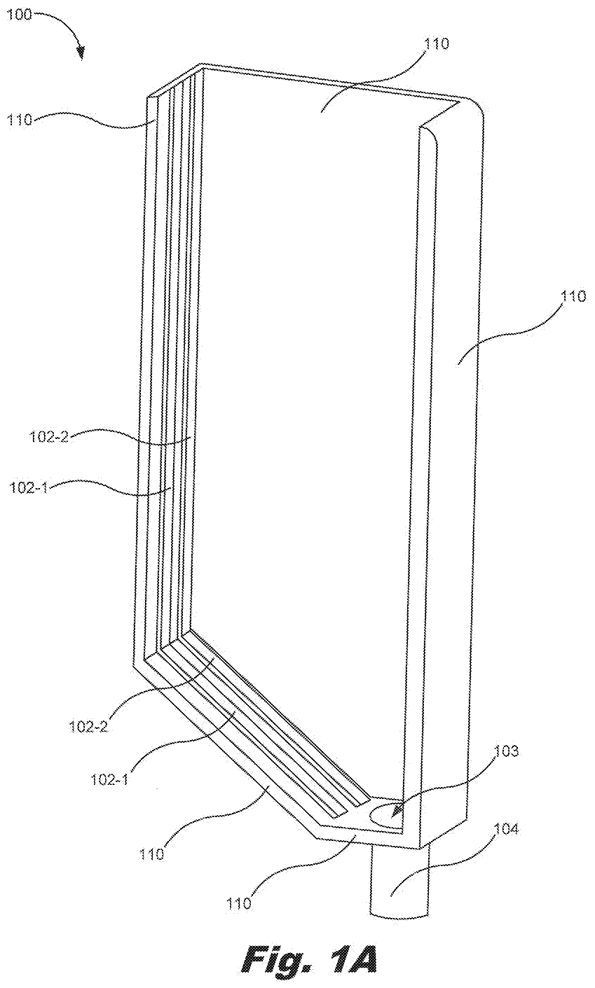

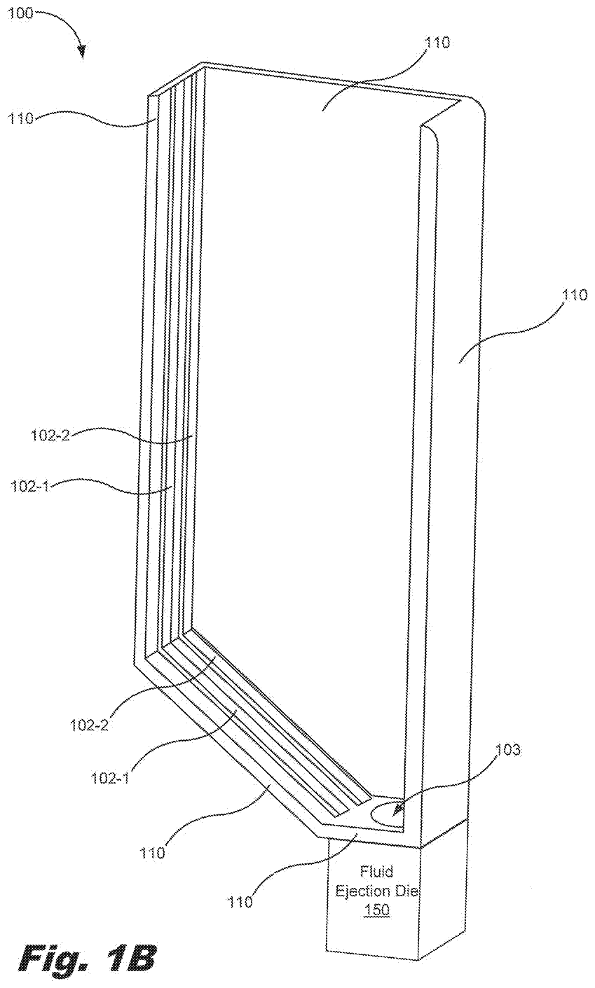

Turning now to the figures, FIG. 1A is a cut away view of a fluid reservoir (100), according to one example of the principles described herein. Further, FIG. 1B is a cut away view of a fluid reservoir (100), according to another example of the principles described herein. The fluid reservoir (100) may be any vessel that may serve to contain a fluid. In one example, the fluid reservoir (100) may be hermetically sealed with the fluid. Further, in one example, the fluid reservoir (100) may serve to contain a fluid. In one example, the fluid may be a printable fluid such as, for example, inks, dyes, a liquid toner, a binding agent, a sinterable material, a thermoplastic material, a biological fluid, a chemical, other dispensable fluids, or combinations thereof. Further, in one example the fluid reservoir (100) may be fluidically coupled to a printhead. In this example, the printhead may include a number of fluid ejection dies fluidically coupled to the reservoir (100) for dispensing the fluid onto a substrate.

The fluid reservoir (100) may have any size, dimension and internal volume to allow for the fluid reservoir to serve as at least a portion of an ink delivery system. In one example, the fluid reservoir (100) may be fluidically coupled to a number of printheads where the printheads are controlled to print the fluid on a substrate. In another example, the fluid reservoir (100) may be integrated with a fluid ejection die (150) as depicted in FIG. 1B. In this example, the fluid reservoir (100) may be fluidically coupled to the fluid ejection die (150). The fluid ejection die (150) may include, for example, a silicon substrate, a number of slots fluidically coupled to a number of fluid firing chambers, a number of nozzles and other elements of a fluid ejection die to allow for the fluid contained within the fluid reservoir (100) to be ejected onto a target substrate.

The fluid reservoir (100) may include a housing (101). The housing may include any number of walls (110) to serve to contain the fluid, and define an interior chamber of the housing (101). In FIGS. 1A and 1B, the cut away view of a fluid reservoir (100) depicts several walls (110) with a top and side wall (110) removed to allow for the viewing of the interior of the housing (101). An aperture (103) may be defined within at least one wall (110) of the fluid reservoir (100) to allow for the fluid contained in the fluid reservoir (100) to flow to other portions of the fluid delivery system. A port (104) may also be formed on at least one of the walls (110) and fluidically coupled to the aperture (103) to serve as a guide or duct for the fluid leaving the fluid reservoir (100).

The fluid reservoir (100) may further include a number of electrical components or traces (102-1, 102-2, collectively referred to herein as 102) that are used to detect the presence of fluid within the fluid reservoir (100), detect the level of fluid within the fluid reservoir (100), or a combination thereof. In one example, the electrical components (102-1, 102-2) may be formed on an interior of the fluid reservoir (100) by depositing electrically conductive material on at least one wall (110) of the housing (101). In another example, the electrical components (102-1, 102-2) may be formed on an interior of the fluid reservoir (100) as a molded interconnect device (MID). An MID is an injection-molded thermoplastic part with integrated electronic circuit traces formed thereon. MID uses high temperature thermoplastics and structured metallization to form the fluid reservoir (100).

In one example, the electrical components (102-1, 102-2) of the fluid reservoir (100) may be formed using a laser direct structuring (LDS) process that uses a thermoplastic material, doped with a non-conductive, metallic, inorganic compound activated by a laser. In this example, the housing (101) may be formed through injection molding. The laser may then write the course of the electrical components (102-1, 102-2) on the plastic. Where the housing (101) is exposed to the electromagnetic radiation provided by laser, the metal additive forms a micro-rough track. The metal particles of this track form the nuclei for the subsequent metallization. The laser-exposed housing (101) is placed in an electroless copper bath, and the various conductor path layers of the electrical components (102-1, 102-2) arise those portions of the housing (101) exposed to the electromagnetic radiation of the laser. Any number of successively layer of metals such as copper, nickel and gold may be deposited on the portions of the housing (101) exposed to the electromagnetic radiation of the laser. LDS processes allow for the precise, computer-aided formation of the electrical components (102-1, 102-2) on the interior of the housing (101) of the fluid reservoir (100).

In another example, the electrical components (102-1, 102-2) of the fluid reservoir (100) may be formed using a deposition process where a conductive material is deposited on the interior surfaces of the housing (101). In this example, the conductive material may be deposited using, for example, a three-dimensional (3D) printing device.

FIGS. 1A and 18 depicts two rows of electrical components (102-1, 102-2) formed on the interior of the housing (101) of the fluid reservoir (100). However, any number or number of sets of electrical components (102-1, 102-2) may be formed on the housing (101). In one example, the two sets of electrical components (102-1, 102-2) serve as redundant elements with respect to one another. In another example, a single set of electrical components (102-1, 102-2) are formed on the housing. Further, in one example, the set of electrical components (102-1, 102-2) are coupled to processing circuitry of an electronic device such as, for example, a printing device. In this example, the set of electrical components (102-1, 102-2) act as sensors for the electrical device in determining the level of fluid within the fluid reservoir (100).

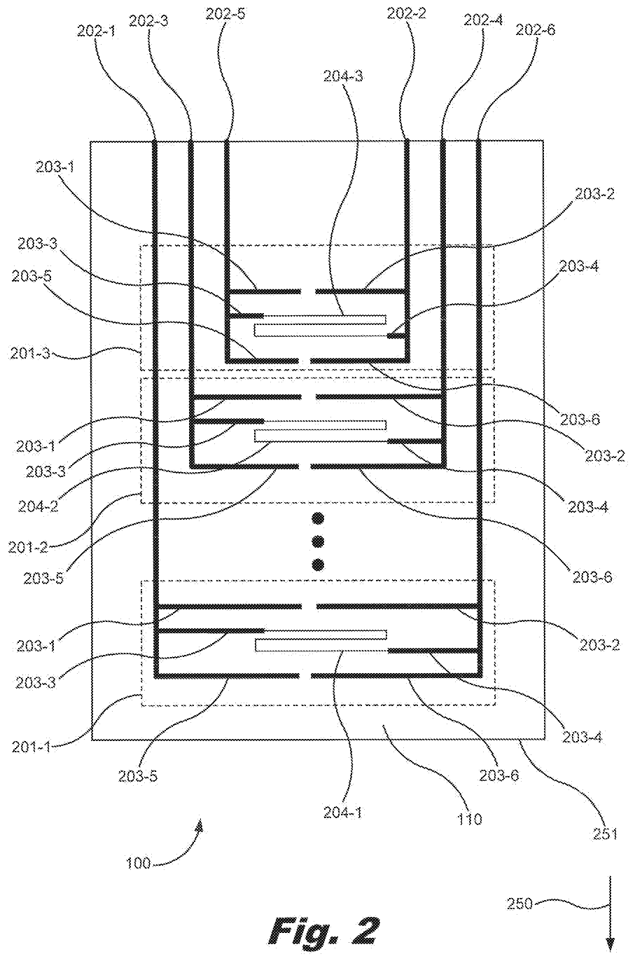

FIG. 2 is a diagram of the electrical components (102-1, 102-2) of the fluid reservoir (100), according to one example of the principles described herein. The electrical components (102) of the fluid reservoir (100) may include a number of fuses (201-1, 201-2, 201-3, collectively referred to herein as 201). The fuses (201) are arranged along a length of the fluid reservoir (100). In one example, the fuses (201) form an array disposed along a gravitationally oriented side of the fluid reservoir (100) with arrow (250) indicating the direction of the force of gravity. In this manner, the fluid disposed within the fluid reservoir (100) is drawn to the bottom (251) of the fluid reservoir (100), and the level of the fluid within the fluid reservoir (100) may be detected. In one example, the fuses (201) may be parasitic resistive elements that, when tripped, indicate the level of the fluid at discrete levels since the fuses (201) are located at discrete levels within the fluid reservoir (100). Thus, the level within the fluid reservoir (100) at which the fuses (201) are located define a corresponding level of fluid when the fuses (201) are tripped.

FIG. 2 depicts three fuses (201-1, 201-2, 201-3) in an array of fuses (201) as indicated by the separate dashed boxes. However, any number of fuses (201) may be included in the fluid reservoir (100). For example, the fluid reservoir (100) may include between one and thousands of fuses (201). In another example, the fluid reservoir (100) may include twelve of fuses (201). The number of fuses (201) in the array of fuses (201) define the granularity and precision of a resulting fluid level measurement provided by the fuses (201).

Each fuse (201) may be any type of low resistance resistor that acts as a sacrificial device to provide overcurrent protection of a load or source circuit. Each fuse (201) may include a metal wire or strip that melts when too much current flows through it, interrupting the circuit that it connects. The fuses (201) interrupt an excessive current, and the fluid reservoir (100) and the electronic device the fluid reservoir (100) is coupled to interprets this interruption of current as an indication of a level of fluid within the fluid reservoir (100).

Each fuse (201) in the fluid reservoir (100) may include a number of traces (202-1, 202-2, 202-3, 202-4, 202-5, 202-6, collectively referred to herein as 202). The traces (202) may include first traces (202-1, 202-3, 202-5) that couple a first end of the fuses (201) to a data processing device, and second traces (202-2, 202-4, 202-6) that couple a second end of the fuses (201) to the data processing device. In one example, the second traces (202-2, 202-4, 202-6) may be combined into one retum path such that the second traces (202-2, 202-4, 202-6) have a common trace design. The data processing device may be any device capable of detecting the overloading of the fuses (201) and uses that detected event to determine a level of fluid within the fluid reservoir (100).

Each of the fuses (201) may also include a number of electrodes (203-1, 203-2, 203-3, 203-4, 203-5, 203-6, collectively referred to herein as 203) that extend from the traces (202). In one example, each fuse (201) include six electrodes (203). A first pair of electrodes (203-1, 203-2) and a second pair of electrodes (203-5, 203-6) form parasitic resistors that allow for current to flow through its associated fuse (201) in the presence of the fluid contained within the fluid reservoir (100), but does not allow for current to flow when the fluid is not present.

A filament (204-1, 204-2, 204-3, collectively referred to herein as 204) may be electrically coupled between a third pair of electrodes (203-3, 203-4). The filament (204) may be any material that acts as the breakdown portion of the fuse (201). The filament (204) may have any width, thickness, or dimension, and may be made of any material that allows the filament (204) to breakdown when a threshold of current flows through it. In one example, the filament may be a thin metal trace that is thinner than the electrodes (203) and the traces (202). Further, in one example, the filament may be made of metals such as aluminum, copper, nickel, tantalum, gold, or metal alloys.

Further, the filament (204) may be laid out within the fuses (201) in any pattern or arrangement that allows for the filament (204) to breakdown when a threshold of current flows through it. In one example, the filament (204) may be laid out in a serpentine pattern to provide a threshold level of resistance at the filament (204) as depicted in FIG. 2. In one example, the electrodes (203) and the filament (204) may be electrically coupled in parallel to one another.

In one example, the electrodes (203) and the filament (204) may be made of the same material. In this example, the electrodes (203) may have a relatively wider width than the filament (204) as depicted in the figures in order to allow the electrodes (203) to carry higher currents than the filament (204). This is because a maximum current density is equivalent for the same material, but not equivalent for larger widths of the same material. In another example, the electrodes (203) and the filament (204) may be made of different material. The materials and widths of the electrodes (203) and the filament (204) may be adjusted to provide for a maximum current density.

If and when too high of a current flows through the filament (204), the filament (204) rises to a higher temperature or electron migration raises and either directly melts or melts a soldered joint within the fuse (201). This melting of the filament (204) or a connection thereto opens the circuit, and may be referred to as a tripping of the fuse (201) or a breakdown of the fuse (201). The filament (204) may be made of, for example, any metal such as zinc, copper, silver, and aluminum, or metal alloys to provide stable and predictable breakdown characteristics of the filament (204). The fuse may maintain its threshold rated current indefinitely, and melt quickly upon exposure to a small excess in that threshold. Further, in one example the filament (204) may be manufactured to not be damaged by minor harmless surges of current, and not oxidize or change its behavior after extended lengths of service.

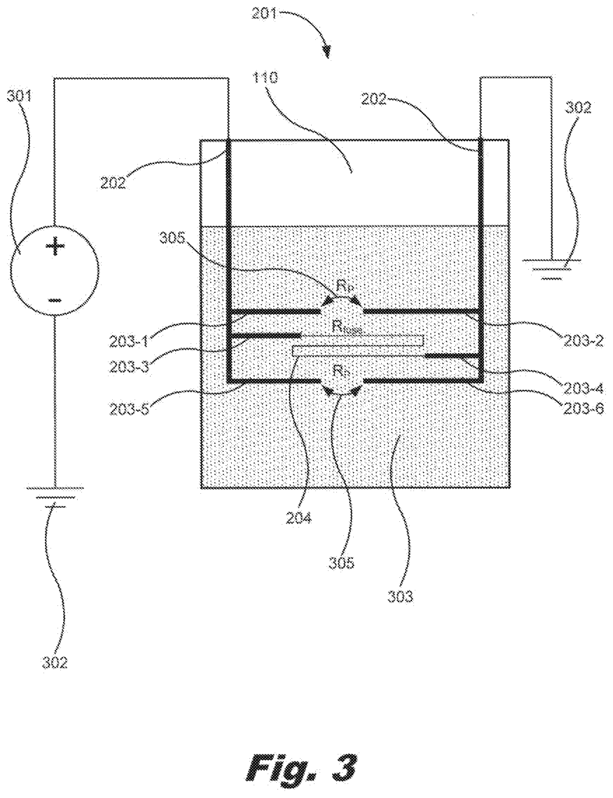

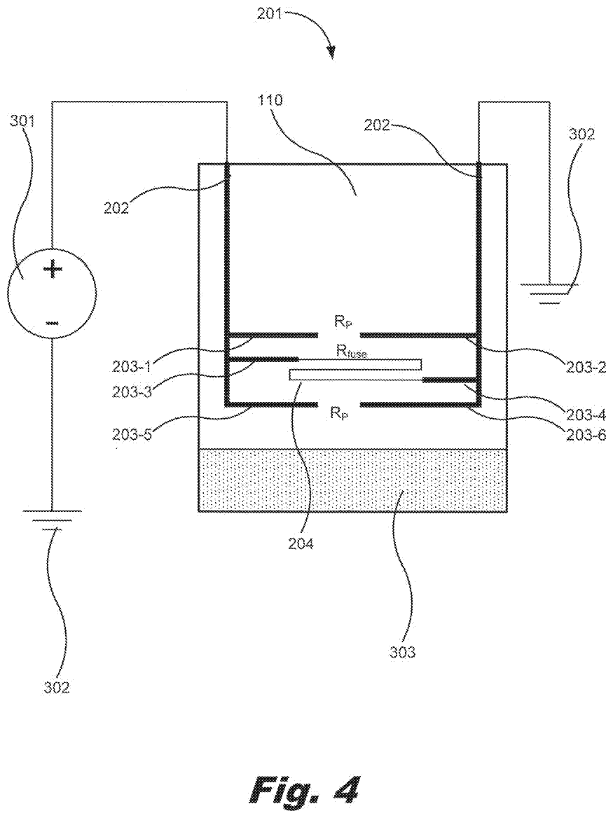

The function of the fuses (201) as indicators of a level of fluid within the fluid reservoir (100) will now be described in connection with FIGS. 3 and 4. FIG. 3 is a diagram of the fluid reservoir (100) of FIGS. 1A and 1B during a fluid analysis process, according to one example of the principles described herein. FIG. 4 is a diagram of the fluid reservoir (100) of FIGS. 1A and 1B during a fluid analysis process, according to one example of the principles described herein. The circuit depicted in FIGS. 3 and 4 include a single fuse (201). However, each fuse (201) included within the fluid reservoir (100) is electrically coupled to the various elements described herein.

A pulse current supply (301) electrically coupled to ground (302) is also electrically coupled to a first trace (202) of the fuse (201). The pulse current supply (301) provides a current to flow through the fuse (201). Further, a second trace (202) of the fuse (201) is electrically coupled to ground (302). The voltage and current provided by the pulse current supply (301) may be characterized for the design of the fuses (201) so that the tripping or breakdown threshold is realized between a wet and dry state where the fluid is and is not present, respectively.

As depicted in FIG. 3, a fluid (303) is present in the fluid reservoir (100) and covers the fuse (201). The fuse (201) may be located anywhere along a height of the fluid reservoir (100) as part of the electrical components (102-1, 102-2) depicted in FIGS. 1A and 1B. In this state, the fuse (201) operates without tripping or breaking down due to the inclusion of the first and second pairs of electrodes (203-1, 203-2, 203-5, 203-6). Further, the presence of the fluid (303) also provides for rapid heat transfer from the fuse (201) as compared to, for example, air. Thus, the thermal conductivity provided by the fluid (303) itself also prevents the fuse (201) from tripping or breaking down. These electrodes (203-1, 203-2, 203-5, 203-6) have a resistance (RP) and are able to reduce the flow of current through the filament (204) by allowing the current to flow through the first and second pairs of electrodes (203-1, 203-2, 203-5, 203-6) and the fluid (303) as indicated by arrows (305). The distance between the ends of the first and second pairs of electrodes (203-1, 203-2, 203-5, 203-6), the size of the first and second pairs of electrodes (203-1, 203-2, 203-5, 203-6), the size of the filament (204), the materials from which the first and second pairs of electrodes (203-1, 203-2, 203-5, 203-6) and the filament (204) are made of, the length of the filament (204), the layout of the filament (204), the resistance (Ri) of the filament (204), other resistive parameters of the fuse (201), and combinations thereof may be adjusted to allow for the fuse (201) to function and not trip or breakdown when exposed to the fluid (303) and allow for a margin of operation.

In FIG. 4, the level of the fluid (303) within the fluid reservoir (100) has dropped due to the electronic device such as, for example, a printing device having consumed the fluid (303). In this example, the fluid (303) has dropped below the fuse (201), and the first and second pairs of electrodes (203-1, 203-2, 203-5, 203-6) and filament (204) are no longer in contact with the fluid (303) but are exposed to, of example, air. Because exposure to the air does not allow for current to flow through the parasitic resistors formed by the first and second pairs of electrodes (203-1, 203-2, 203-5, 203-6) and because air does not thermally conduct heat as well as the fluid (303), more current is forced through the filament (204). In this state, the filament (204) is tripped or breaks down such that the circuit is broken.

The processing circuitry of the electronic device electrically and electronically coupled to the fluid reservoir (100) may be programmed to identify when the filament (204) breaks down and the fuse (201), and process the tripping of the fuse (201) at that level of the fluid reservoir (100) as indicative of the fluid (303) having been depleted past that level of the fluid reservoir (100). In this manner, the level of fluid (303) within the fluid reservoir (100) may be determined.

The fuses (201) within the fluid reservoir (100) are, in this manner, create a two-state memory. This two-state memory may include a number of functioning fuses (201) that have not broken down or been tripped. This state may be identified as a programming “0” that indicates a low resistance state within the fuses (201) and a level of fluid (303) within the fluid reservoir (100) that is at least as high as the highest functioning fuse (201). Also, this two-state memory may include a number of non-functioning, tripped fuses (201) that have broken down. This state may be identified as a programming “1” that indicates a high resistance state within the fuses (201) and a level of fluid (303) within the fluid reservoir (100) that is at least as low as the lowest non-functioning fuse (201). In this example, each fuse (201) may be viewed as a memory bit where the indication of a “0” or “1” is stored in a storage device of the electronic device to which the fluid reservoir (100) is communicatively coupled. Programming of each bit, in this example, may occur when the fuse (201) moves from a “0” to a “1,” or visa versa. In one example, any bits to be programmed without the ink level guard may be programmed at a dry fluid reservoir (100) stage before fluid (303) has been introduced into the fluid reservoir (100).

In some examples, the level of the fluid (303) may rise to an intermediary level where the fluid level is below the first pair of electrodes (203-1, 203-2) and/or the filament (204), but above the second pair of electrodes (203-5, 203-6). In this situation, the second pair of electrodes (203-5, 203-6) may continue to allow for current to flow through the fuse (201) without tripping the filament (204) by reducing the flow of current through the filament (204) below a threshold by allowing the current to also flow through the second pair of electrodes (203-5, 203-6) and the fluid (303). In this manner, the second pair of electrodes (203-5, 203-6) may serve as a fluid level guard where the fuse (201) remains functional until the fluid (303) drops past the fuse (201) including the second pair of electrodes (203-5, 203-6).

In one example, the fuses (201) may be any fuse that acts as a sacrificial device that is irreversibly tripped when a current load exceeding a threshold is applied to the fuse. In another example, the fuses (201) may be self-resetting fuses that use a thermoplastic conductive element that may be referred to as a polymeric positive temperature coefficient (or PPTC) thermistor that impedes the circuit during an overcurrent condition by increasing device resistance, but, when current is removed, the device will cool and revert to low resistance state. In this example, the programmed bits “0” and un-programmed bits “1” may be differentiated by allowing processing circuitry of an electronic device to read the array of fuses (201) and the circuit as a whole to determine the level of fluid (303) within the fluid reservoir (100). In one example, where at least one of the fuses (201) is a self-resetting fuse, the fluid reservoir (100) may be implemented within a continuous ink supply system where a level of fluid (303) within the fluid reservoir (100) is maintained at a constant level. In this example, the fuses (201) may serve as reminders to a user or an overall system that the fluid level has decreased, indicating an unanticipated failure of the continuous ink supply system.

In still another example, the fuses may be a combination of a sacrificial fuses and self-resetting fuses. In this example, a first, top fuse (201) in the array of fuses (201) may be an irreversible fuse and the remainder of the fuses (201) may be self-resetting fuses. The irreversible fuse may be used to, when tripped, to indicate to a user that the fluid reservoir (100) has been used before, while the remaining self-resetting fuses may allow for the fluid reservoir (100) to be continued to be used to indicate a level of fluid (303) in the reservoir (100). In this manner, a user may be made aware of the age of the fluid reservoir (100) and whether the fluid reservoir (100) may have been previously refilled.

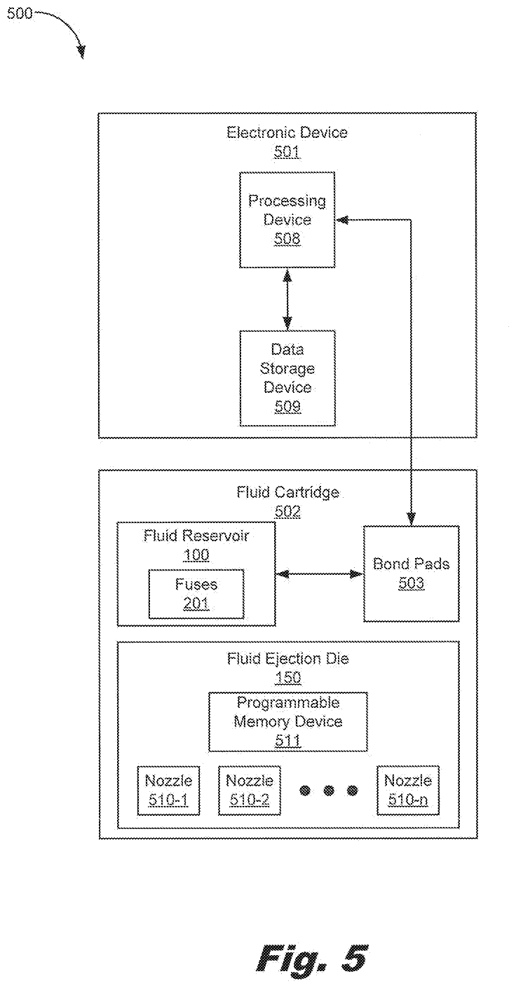

FIG. 5 is a block diagram of a fluid analysis system (500) including the fluid reservoir (100) of FIGS. 1A and 1B, according to one example of the principles described herein. As mentioned herein, the fluid reservoir (100) may be embodied in a fluid ejection device (502), which may also be referred to as a fluid cartridge. The fluid cartridge (502) may be coupled to an electronic device (501). In one example, the fluid cartridge (502) may be an inkjet print cartridge, a printing pen, a fluid supply cartridge that supplies fluid such as, for example, ink, to a number of printheads, or another component associated with a printing device. In this example, the electronic device (501) may be a printing device that controls a number of printheads during a printing process.

As depicted in FIG. 5, the fluid cartridge (502) may include the fluid reservoir (100) and a number of bond pads (503) coupled to, for example, the fuses (201), in order to electrically couple a processing device (508) to the fluid reservoir (100). In one example, the processing device (508) may be located off the fluid cartridge (502), and may be located, for example, on an integrated circuit of the electronic device (501). The fluid reservoir (100) contains the fluid (303) used to form the outcome of, for example, a print job. In one example, the processing device (508) may be located in the electronic device (501), and may be used to instruct the fluid reservoir (100) to determine the level of fluid (303) within the fluid reservoir (100). In another example, the processing device (508) may be located on the fluid cartridge (502), and may be used to relay data processed by the processing device (508) to the electronic device (501).

The electronic device (501) may also include a data storage device (509). The data storage device (509) may store data such as executable program code that is executed by the processing device (508), and may specifically store computer code representing a number of applications that the processor (101) executes to implement at least the functionality described herein. For example, data representing the sensed level of fluid (303) within the fluid reservoir (100) may be stored in the data storage device (509). The data storage device (509) may include various types of memory modules, including volatile and nonvolatile memory. For example, the data storage device (509) of the present example may include Random Access Memory (RAM), Read Only Memory (ROM), and Hard Disk Drive (HDD) memory. Many other types of memory may also be utilized, and the present specification contemplates the use of many varying type(s) of memory in the data storage device (509) as may suit a particular application of the principles described herein. The data storage device (509) may comprise a computer readable medium, a computer readable storage medium, or a non-transitory computer readable medium, among others. For example, the data storage device (509) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The fluid ejection die (150) may correspond to a printhead. In one example, the fluid cartridge (502) may include a plurality of fluid ejection dies. Further, in one example, the fluid cartridge (502) may include at least one fluid ejection die fluidically coupled to the fluid cartridge (502) such that fluid stored in the fluid reservoir (100) of the fluid cartridge (502) may be ejected by the at least one fluid ejection die (150). Each fluid ejection die (150) may include a programmable memory device (511). Further, each fluid ejection die (150) may include a number of nozzles (510-1, 510-2 . . . . 510-n, collectively referred to herein as 510) through which the fluid (303) may be dispensed. In this manner, the nozzles (510) are fluidically coupled to the fluid reservoir (100) in order dispense fluid (303) from the fluid reservoir (100).

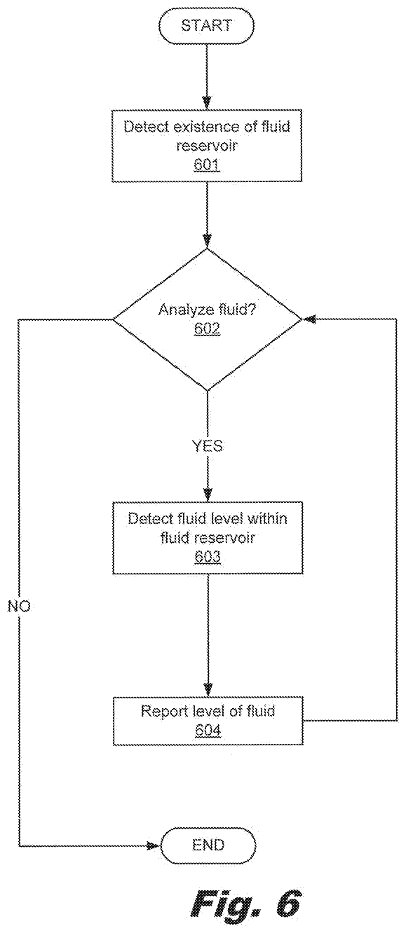

FIG. 6 is a flowchart depicting a method of detecting a level of fluid (303) within a fluid reservoir (100), according to one example of the principles described herein. The method of FIG. 6 may begin by detecting (block 601) the existence of a fluid reservoir (100) within, for example, the electronic device (501) of FIG. 5. For example, the coupling of a fluid reservoir (100) to the electronic device (501) may occur when the electronic device (501) has consumed fluid (303) from a previous fluid reservoir (100) and a new fluid reservoir (100) is coupled to eh electronic device (501). Detection of the fluid reservoir (100) may serve as a prompt to the electronic device (501) to perform an analysis of the fluid (303) within the fluid reservoir (100). In other examples, the fluid (303) within the fluid reservoir (100) may be analyzed at any point during the life of the fluid reservoir (100).

A determination (block 602) as to whether the fluid (303) within the fluid reservoir (100) is to be analyzed is made. If the fluid (303) is not to be analyzed (block 602, determination NO), the method of FIG. 6 may terminate. However, if the fluid (303) is to be analyzed (block 602, determination YES), a level or amount of fluid (303) may be detected (block 603). In one example, the level of fluid (303) within the fluid reservoir (100) may be detected with the processing device (508).

The level or amount of fluid (303) within the fluid reservoir (100) may be reported (block 604). In one example, the level or amount of fluid (303) within the fluid reservoir (100) may be reported (block 604) to the processing device (508) of the electronic device (501) in order to process the data describing the level or amount of fluid (303) or display information to a user regarding the level or amount of fluid (303). Further, in one example, the level or amount of fluid (303) within the fluid reservoir (100) may be detected at any time and at any frequency.

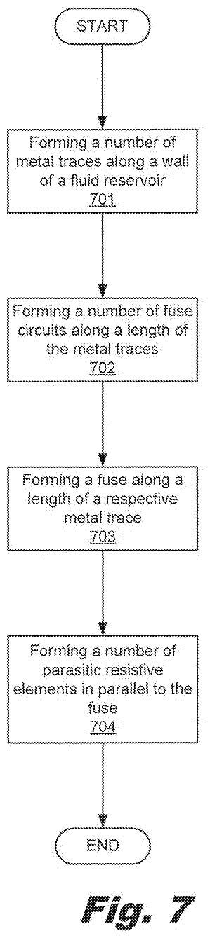

FIG. 7 is a flowchart depicting a method of forming a fluid level sensor, according to one example of the principles described herein. The method of FIG. 7 may begin by forming (block 701) a number of metal traces (102) along a wall (110) of a fluid reservoir (100). Forming (block 701) the number of metal traces along the wall (110) of the fluid reservoir (100) may include forming the number of metal traces (102) using laser direct structuring (LDS).

The method may further include forming (block 702) a number of fuse circuits (201) along a length of the metal traces (102). Forming the fuse circuits (201) may include for each of the fuse circuits, forming (block 703) a fuse (201) along a length of a respective metal trace (102), and forming (block 704) a number of parasitic resistive elements (203) in parallel to the fuse (201). In one example, the parasitic resistive elements may reduce current flow through the fuse (201) in the presence of a fluid (303) contained within the fluid reservoir (100). As described above, the parasitic resistive elements (203) increase the current flow through the fuse (201) when the parasitic resistive elements (203) are not in the presence of the fluid (303), and the fuse (201) trips in response to the increase in current flow. The location of the number of fuse circuits (201) within the fluid reservoir (100) define a corresponding number of levels of fluid (303) within the fluid reservoir (100). Further, as described herein, a width within the fuses (201), a width of the metal traces (102), a thickness of the metal traces (102), a design of the parasitic resistive elements (203) within the fuse circuits (201), or combinations thereof may define a breaking capacity of the fuse circuit (201).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processing device (508) of the electronic device (501) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a fluid reservoir may include a number of metal traces along a wall of the fluid reservoir, and a number of fuse circuits along a length of the metal traces. Each of the fuse circuits may include a fuse along a length of a respective metal trace, and a number of parasitic resistive elements in parallel to the fuse. The parasitic resistive elements reduce current flow through the fuse in the presence of a fluid contained within the fluid reservoir.

The fluid level sensor and fluid reservoir described herein reduces silicon complexity that may exist in more complicated systems and devices, and decreases the cost of the fluid reservoir and any associated printhead in which the fluid reservoir is incorporated. Further, the fluid level sensor and fluid reservoir described herein reduces costs associated with the inclusion of memory devices on or off the reservoir by using a two-state memory in the reservoir. Further, the ability to provide a one-time-programmable ink level sensor provides for a more reliable fluid measurement during a lifetime of the reservoir.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of forming a fluid level sensor comprising:
forming a number of metal traces along a wall of a fluid reservoir;
forming a number of fuse circuits along a length of the metal traces, wherein forming the fuse circuits comprises, for each of the fuse circuits:
forming a fuse along a length of a respective metal trace; and
forming a number of parasitic resistive elements in parallel to the fuse, the parasitic resistive elements reducing current flow through the fuse in the presence of a fluid contained within the fluid reservoir.

2. The method of claim 1, wherein:
the parasitic resistive elements increase the current flow through the fuse when the parasitic resistive elements are not in the presence of the fluid, and
the fuse trips in response to the increase in current flow.

3. The method of claim 1, wherein forming the number of metal traces along the wall of the fluid reservoir comprises forming the number of metal traces using laser direct structuring (LDS).

4. The method of claim 1, wherein a location of the number of fuse circuits within the fluid reservoir define a corresponding number of levels of fluid within the fluid reservoir.

5. The method of claim 1, wherein a width within the fuses, a width of the metal traces, a thickness of the metal traces, a design of the parasitic resistive elements within the fuse circuits, or combinations thereof define a breaking capacity of the fuse circuit.

6. A fluid reservoir comprising:
a number of metal traces along a wall of the fluid reservoir;
a number of fuse circuits along a length of the metal traces, wherein each of the fuse circuits comprises:
a fuse along a length of a respective metal trace; and
a number of parasitic resistive elements in parallel to the fuse, the parasitic resistive elements reducing current flow through the fuse in the presence of a fluid contained within the fluid reservoir.

7. The fluid reservoir of claim 6, wherein the number of metal traces along the wall of the fluid reservoir are formed using laser direct structuring (LDS).

8. The fluid reservoir of claim 6, wherein:
the parasitic resistive elements increase the current flow through the fuse when the parasitic resistive elements are not in the presence of the fluid, and
the fuse trips in response to the increase in current flow.

9. The fluid reservoir of claim 6, wherein a location of the number of fuse circuits within the fluid reservoir define a corresponding number of levels of fluid within the fluid reservoir.

10. The fluid reservoir of claim 6, wherein a width within the fuses, a width of the metal traces, a thickness of the metal traces, a design of the parasitic resistive elements within the fuse circuits, or combinations thereof define a breaking capacity of the fuse circuit.

11. The fluid reservoir of claim 8, wherein, in response to the fuse tripping in response to the increase in current flow, the fluid reservoir sends a signal to a programmable memory device to permanently change data relating to the fuse.

12. A fluid cartridge comprising:
a fluid reservoir comprising walls defining an interior chamber, the fluid reservoir to store fluid in the interior chamber;
a number of fuse circuits formed along a length of at least one wall of the fluid reservoir such that a respective position of each respective fuse circuit of the number of fuse circuits corresponds to a fluid level of the fluid reservoir, each respective fuse circuit to change state when the fluid level of the fluid reservoir crosses the respective position of the respective fuse circuit; and
a fluid ejection die fluidly coupled to the fluid reservoir, the fluid ejection die comprising nozzles to eject fluid conveyed from the fluid reservoir, the fluid ejection die further comprising a programmable memory device electrically coupled to the number of fuse circuits, the programmable memory device to permanently change data stored thereon responsive to a change in state of each respective fuse circuit.

13. The fluid cartridge of claim 12, wherein:
each fuse circuit comprises:
a fuse; and
a number of parasitic resistive elements in parallel to the fuse, the parasitic resistive elements reducing current flow through the fuse in the presence of a fluid contained within the fluid reservoir, and
each respective fuse circuit does not change its state when the fluid level of the fluid reservoir does not cross the respective position of the respective fuse circuit.

14. The fluid cartridge of claim 12, wherein:
each fuse circuit comprises:
a fuse; and
a number of parasitic resistive elements in parallel to the fuse, the parasitic resistive elements increasing current flow through the fuse to a point of tripping when at least one parasitic element is not in the presence of a fluid contained within the fluid reservoir, and
each respective fuse circuit changes its state when the fluid level of the fluid reservoir crosses the respective position of the respective fuse circuit.

15. The fluid cartridge of claim 14, wherein, in response to the fuse tripping in response to the increase in current flow, a signal is sent to a programmable memory device to the programmable memory device to permanently change data relating to the respective fuse circuit.
